(19) United States
(12) Patent Application Publication
(10) Pub. No.: US 2012/0294053 A1
(43) Pub. Date: Nov. 22, 2012

(54) METHOD FOR PROTECTING A CONVERTER AND A CONVERTER IMPLEMENTING THE METHOD

(75) Inventors: Chao Yan, Shanghai (CN); Yi-Qing YE, Shanghai (CN); Chong-Feng ZHENG, Shanghai (CN); Jian-Ping YING, Shanghai (CN)

(73) Assignee: DELTA ELECTRONICS (SHANGHAI) CO., LTD., Shanghai (CN)

(21) Appl. No.: 13/241,250

(22) Filed: Sep. 23, 2011

(30) Foreign Application Priority Data
May 18, 2011 (CN) 201110130030.0

(51) Int. Cl. H02H 7/125

(52) U.S. Cl. 363/53

(57) ABSTRACT

A method for protecting a converter device comprises the steps of: detecting an alternating current signal; when the alternating current signal is abnormal, generating an activating signal according to the abnormal alternating current signal; generating a control signal according to the activating signal; and controlling at least one synchronous rectifying power switch of the converter device according to the control signal. Furthermore, a converter device which implements the method is provided.

### RELATED APPLICATIONS

This application claims priority to Chinese Application Serial Number 201110130030.0, filed May 18, 2011, which is herein incorporated by reference.

### BACKGROUND

1. Field of Invention

The embodiment of the present invention relates generally to a protecting method and, more particularly, to a method for protecting a converter.

2. Description of Related Art

In today's world of rapid development in science, much effort is being put forth to realize high efficiency, high power density, high reliability, and low cost in more and more power source products.

For reducing interference of an electric grid caused by power harmonic waves and decreasing the noise of the electric grid, a power factor correction (PFC) circuit in an AC/DC converter is applied extensively in the areas of communication power, server power, civil power, aviation power, etc.

Advances in components and the development of topology allow converters to be more efficient. With the use of PFC without a bridge rectifier, synchronous rectifying technology, and SiC components, the efficiency of PFC increases significantly. Synchronous rectifying technology can reduce power loss due to the turn-on voltage of a diode. However, a reliable control tactic is needed to ensure that the reliability of power will not be decreased, and there will be no additional damage when synchronous rectifying is turned on or turned off.

In a typical converter protection device, after an alternating current signal flows through a filter, the alternating current signal is transported to the converter. The converter then converts the alternating current signal into a direct current signal to provide to the device needing electric power. The converter protection device comprises a sampling circuit and a protection circuit. The sampling circuit is operable to sample abnormal signals in the circuit, and the abnormal signals are transported to the protection circuit. The abnormal signals are subsequently compared with a reference voltage, and the protection circuit is activated. When the abnormal signals are generated in the circuit, the driver in the converter is turned off to achieve the goal of protecting the converter. However, the load needs continuous supply in some conditions, and so it is not possible to turn off the converter when the alternating current signal is abnormal.

In summary, the existing apparatus and techniques still have obvious defects and need further improvement. In order to solve the above problems, those skilled in the art are trying hard to find a solution, but no suitable method has been proposed.

### SUMMARY

A method for protecting a converter device is provided, which addresses the problem of a converter device needing to be turned off when an alternating current signal is abnormal.

Thus, one aspect of the embodiment of the present invention is to provide a method for protecting a converter device. The method for protecting a converter device comprises: detecting an alternating current signal; when the alternating current signal is abnormal, generating an activating signal according to the abnormal alternating current signal; generating a control signal according to the activating signal; and controlling at least one synchronous rectifying power switch of the converter device according to the control signal.

In one embodiment of the present invention, the method for protecting a converter device further comprises: generating a driving signal to drive the synchronous rectifying power switch; and stopping generating the driving signal according to the control signal so as to turn off the synchronous rectifying power switch.

In another embodiment of the present invention, the step of generating the control signal according to the activating signal comprises: comparing the activating signal with a reference voltage to generate the control signal.

In yet another embodiment of the present invention, the step of controlling the synchronous rectifying power switch according to the control signal comprises: turning off the synchronous rectifying power switch according to the control signal.

In still another embodiment of the present invention, the method for protecting a converter device further comprises: amplifying the alternating current signal.

In yet another embodiment of the present invention, the alternating current signal is an alternating current signal of a front end circuit of the converter device.

In another aspect of the embodiment of the present invention, a protection device is provided. The protection device comprises a detecting circuit and a protection circuit. The detecting circuit is operable to detect an alternating current signal, wherein when the alternating current signal is abnormal, the detecting circuit generates an activating signal according to the abnormal alternating current signal; and the protection circuit is operable to receive the activating signal and generate a control signal according to the activating signal, wherein at least one synchronous rectifying power switch in a converter device is controlled according to the control signal.

In one embodiment of the present invention, the alternating current signal is an alternating current signal of a front end circuit of the converter device.

In another embodiment of the present invention, the protection device further comprises a driving circuit. The driving circuit is operable to generate the driving signal to drive synchronous rectifying power switch and receive the control signal for stopping generating the driving signal according to the control signal so as to turn off the synchronous rectifying power switch.

In yet another embodiment of the present invention, the protection circuit further comprises an amplifier circuit. The amplifier circuit is electrically connected to detecting circuit, receives the alternating current signal, and amplifies the alternating current signal to provide the amplified alternating current signal to the detecting circuit.

In still another embodiment of the present invention, the protection circuit comprises a comparing circuit, and the comparing circuit is operable to compare the activating signal with a reference voltage to output the control signal.

In yet another embodiment of the present invention, the detecting circuit is selected from the group consisting of a current transformer detecting circuit, a resistor detecting circuit, a hall sensor detecting circuit, and a photocoupler detecting circuit.

In yet another aspect of the embodiment of the present invention, a converter device is provided. The converter device comprises a front end circuit, an AC to DC converter, and a protection device. The front end circuit is operable to perform a preliminary process on an alternating current signal. The AC to DC converter is electrically connected to the front end circuit and converts the alternating current signal into a direct current signal.

The AC to DC converter comprises a plurality of diodes and at least one synchronous rectifying power switch. The diodes are disposed to convert the alternating current signal into the direct current signal. Each of the synchronous rectifying power switches is disposed with one of the diodes in parallel. The protection device comprises a detecting circuit and a protection circuit. The detecting circuit is electrically connected to front end circuit and is operable to detect alternating current signal, wherein when the alternating current signal is abnormal, the detecting circuit generates an activating signal according to the abnormal alternating current signal. The protection circuit is electrically connected to the AC to DC converter and the detecting circuit, receives the activating signal, and generates the control signal according to the activating signal, wherein the synchronous rectifying power switch is controlled according to the control signal.

In one embodiment of the present invention, the front end circuit comprises a filter circuit, and the filter circuit filters the alternating current signal.

In another embodiment of the present invention, the power switch is switched according to the frequency of the alternating current signal.

In yet another embodiment of the present invention, the converter device further comprises a driving circuit. The driving circuit is operable to generate a driving signal to drive the synchronous rectifying power switch, and receives the control signal for stopping generating the driving signal according to the control signal so as to turn off the synchronous rectifying power switch.

In still another embodiment of the present invention, the converter device further comprises an amplifier circuit. The amplifier circuit is electrically connected to the detecting circuit, receives the alternating current signal, and amplifies the alternating current signal to provide the amplified alternating current signal to the detecting circuit.

In yet another embodiment of the present invention, the protection circuit comprises a comparing circuit, and the comparing circuit compares the activating signal with a reference voltage to output the control signal.

In still another embodiment of the present invention, the detecting circuit is selected from the group consisting of a current transformer detecting circuit, a resistor detecting circuit, a hall sensor detecting circuit, and a photocoupler detecting circuit.

In summary, the embodiments of the present invention provide a method for protecting a converter device and a converter device implementing the method, which address the problem of the converter device needing to be turned off when an alternating current signal is abnormal. Through use of the method and converter device of the present invention, the problem of the diodes burning out when the alternating current signal is abnormal can be avoided, and continued operation of the AC to DC converter in the diode rectification mode may be ensured so that electric power may be continuously provided to the load.

### BRIEF DESCRIPTION OF THE DRAWINGS

The invention can be more fully understood by reading the following detailed description of the embodiments, with reference made to the accompanying drawings as follows:

FIG. 1 schematically shows a circuit block diagram of a converter device according to one embodiment of the present invention.

FIG. 2 schematically shows a circuit diagram of the converter device of FIG. 1 according to an embodiment of the present invention.

FIG. 3A schematically shows a circuit diagram of a converter device according to another embodiment of the present invention.

FIG. 3B schematically shows a control waveform diagram of the converter device of FIG. 3A according to an embodiment of the present invention.

FIG. 4A schematically shows a waveform diagram of a negative phase change in an alternating current signal according to yet another embodiment of the present invention.

FIG. 4B schematically shows a waveform diagram of a positive phase change in an alternating current signal according to yet another embodiment of the present invention.

FIG. 4C schematically shows a waveform diagram of a frequency change of an alternating current signal according to yet another embodiment of the present invention.

FIG. 4D schematically shows a waveform diagram of an alternating current signal when an electric power is cut off at a zero-crossing point according to yet another embodiment of the present invention.

FIG. 5 schematically shows a waveform diagram of a changed relationship between a voltage of a capacitor and a current of the capacitor when an alternating current signal is changing according to still another embodiment of the present invention.

FIG. 6 schematically shows a circuit block diagram of a protection device of FIG. 1 according to an embodiment of the present invention.

FIG. 7A schematically shows a circuit block diagram of a current transformer detecting circuit according to another embodiment of the present invention.

FIG. 7B schematically shows a circuit block diagram of a resistor detecting circuit according to another embodiment of the present invention.

FIG. 7C schematically shows a circuit block diagram of a hall sensor detecting circuit according to another embodiment of the present invention.

FIG. 7D schematically shows a circuit block diagram of a photocoupler detecting circuit according to another embodiment of the present invention.

FIG. 8 schematically shows a circuit diagram of a comparing circuit according to yet another embodiment of the present invention.

FIG. 9A schematically shows a waveform diagram of an input and an output of the converter device of FIG. 1 according to an embodiment of the present invention.

FIG. 9B schematically shows a waveform diagram of an input and an output of the converter device of FIG. 1 according to an embodiment of the present invention.

FIG. 9C schematically shows a waveform diagram of an input and an output of the converter device of FIG. 1 according to an embodiment of the present invention.

FIG. 10 schematically shows a circuit diagram of a power factor correction circuit without a bridge rectifier according to still another embodiment of the present invention.

FIG. 11 schematically shows a circuit diagram of a power factor correction circuit without a bridge rectifier according to yet another embodiment of the present invention.

FIG. 12 schematically shows a circuit diagram of a power factor correction circuit without a bridge rectifier according to still another embodiment of the present invention.

FIG. 13 schematically shows a circuit diagram of a power factor correction circuit without a bridge rectifier according to yet another embodiment of the present invention.

FIG. 14 schematically shows a circuit diagram of a converter device according to still another embodiment of the present invention.

FIG. 15 schematically shows a flow diagram of a method for protecting a converter device according to an embodiment of the present invention.

FIG. 16 schematically shows a flow diagram of a method for protecting a converter device according to another embodiment of the present invention.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers indicate like components throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used herein, “around,” “about” or “approximately” shall generally mean within 20 percent, preferably within 10 percent, and more preferably within 5 percent of a given value or range. Numerical quantities given herein are approximate, meaning that the term “around,” “about” or “approximately” can be inferred if not expressly stated.

As used herein, the terms “comprising,” “including,” “having,” “containing,” “involving,” and the like are to be understood to be open-ended, i.e., to mean including but not limited to.

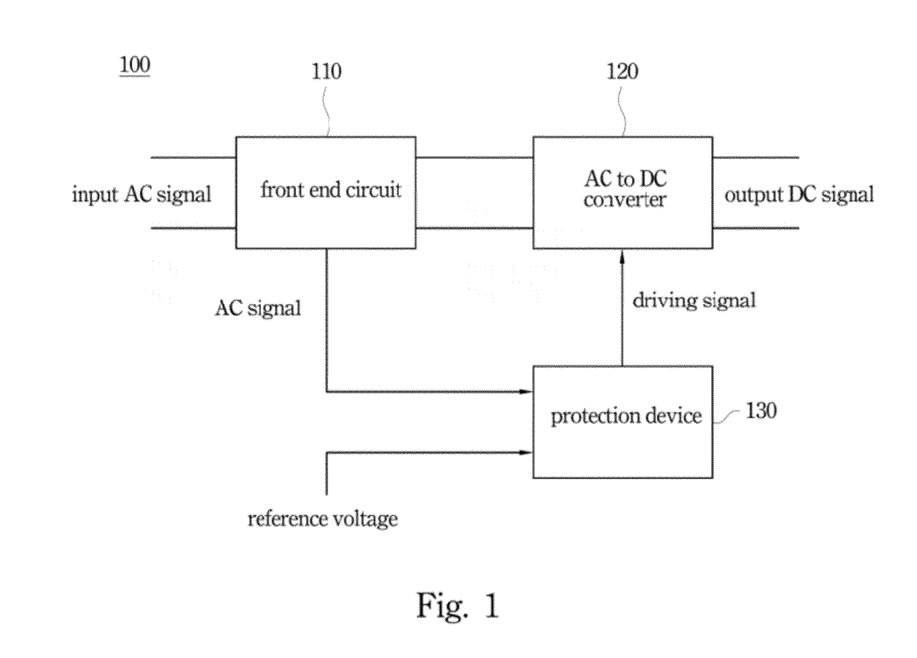

FIG. 1 schematically shows a circuit block diagram of a converter device 100 according to one embodiment of the present invention. The converter device 100 comprises a front end circuit 110, an AC to DC converter 120, and a protection device 130.

The front end circuit 110 is operable to perform a preliminary process on an alternating current signal. The AC to DC converter 120 is electrically connected to the front end circuit 110 and converts the alternating current signal into a direct current signal. The protection device 130 is electrically connected to the front end circuit 110, detects the alternating current signal, and generates a driving signal by processing the alternating current signal.

In an optional embodiment, the alternating current signal is an AC voltage signal or an AC current signal.

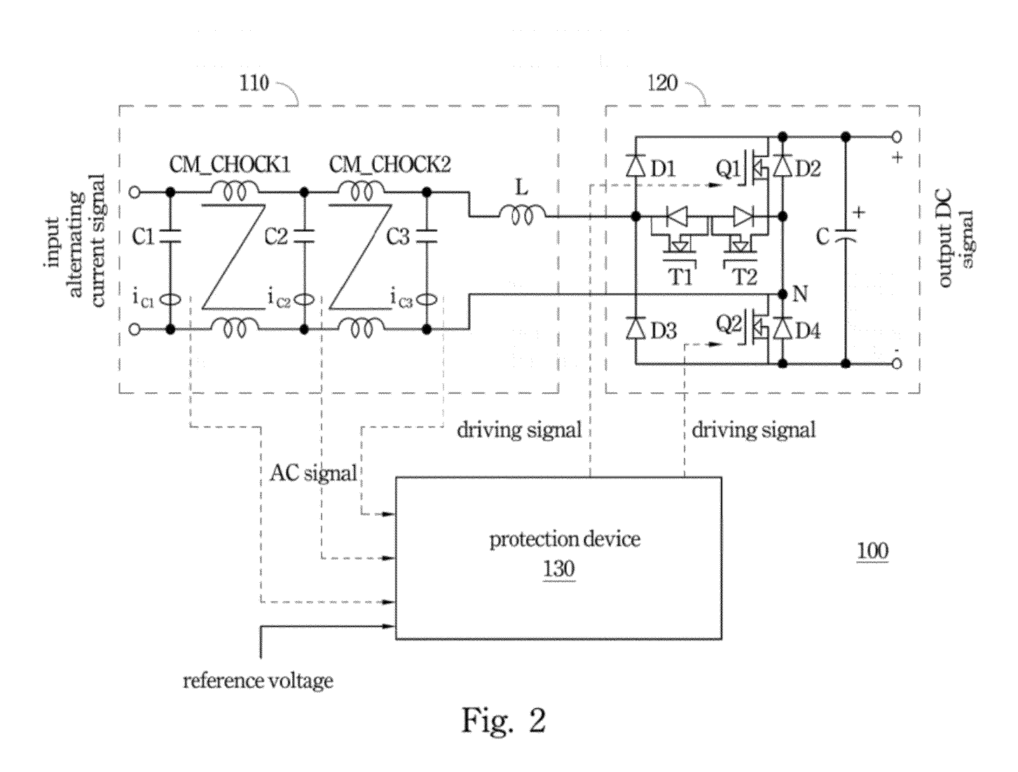

FIG. 2 schematically shows a circuit diagram of the converter device 100 of FIG. 1 according to an embodiment of the present invention. While FIG. 2 schematically shows a circuit diagram of the converter device 100, this is not intended to limit the present invention, and those skilled in the art may change various aspects of the converter device 100 according to need without departing from the spirit or scope of the present invention.

As shown in FIG. 2, the front end circuit 110 is operable to perform a preliminary process on an alternating current signal. The AC to DC converter 120 comprises a plurality of diodes (for example, D1˜D4), and at least one synchronous rectifying power switch (for example, Q1 and Q2, in which Q1 and Q2 can be MOSFETs, namely, metal-oxide-semiconductor field-effect transistors. The diodes are disposed to form a bridge rectifier for converting the alternating current signal into the direct current signal. Each of the synchronous rectifying power switches is disposed with one of the diodes in parallel.

Specifically, the front end circuit 110 can be a filter circuit for filtering the alternating current signal. D1, D2, D3, and D4 are rectifying diodes, in which D1˜D4 are switched according to the frequency of the alternating current signal. In a normal diode, the turn-on voltage of the diode is a constant value (about 0.6V˜1V), and the power loss is increased according to the increased current.

Because of the equivalent on-resistance of power switches decreasing due to developments in power switches, a power switch (for example, a MOSFET) and a diode can be connected in parallel to decrease power loss. The power switch is turned on as soon as the diode is turned on when the diode is connected to the power switch in parallel. At this time, the current flows through the power switch with lower equivalent resistance so as to decrease the voltage drop in the branch circuit to achieve the goal of decreasing power loss. Hence, the power switch is regarded as a synchronous rectifying power switch. In addition, the power switch is turned off as soon as the diode is turned off, and the circuit is in diode rectification mode. Thus, the above-mentioned principle is the synchronous rectification technology. Furthermore, when the power switch is turned on, the power switch is controlled to be turned on and turned off by the driving signal generated by the protection device 130 as shown in FIG. 1.

As shown in FIG. 2, the power switches Q1 and Q2 are synchronous rectifying power switches (for example, MOSFETs), in which the power switch Q1 is connected with the diode D2 in parallel, and the power switch Q2 is connected with the diode D4 in parallel. In circuits where cost is an important consideration, the circuit can be connected with one or two power switches in parallel according to actual requirements. To simplify the circuit and keep cost down, only the diode D2 and the diode D4 are connected respectively with the power switch Q1 and power switch Q2 in parallel as shown in FIG. 2.

However, each of the diodes can be connected with a power switch in parallel or connected with a plurality power switches in parallel in some circuits where efficiency is more important. However, such different alternatives are not intended to limit the present invention, and those skilled in the art can selectively dispose the power switch and the diode according to actual requirements without departing from the spirit or scope of the present invention.

Owing to the diode being a passive component and the power switch being an active component, the synchronous rectifying technology needs a reliable protection method to ensure that no control error occurs in the diode connected with the power switch in parallel, and the circuit can operate reliably. Therefore, the embodiment of the present invention provides a converter device 100 and a method for protecting the converter device will be described below.

The converter device with synchronous rectifying technology in the situation where the alternating current signal is normal and the alternating current signal is abnormal will be described, and then the manner in which the converter device 100 is used and the method for protecting the converter device provided by the embodiment of the present invention to overcome the problem produced in the situation where the alternating current signal is abnormal will be described.

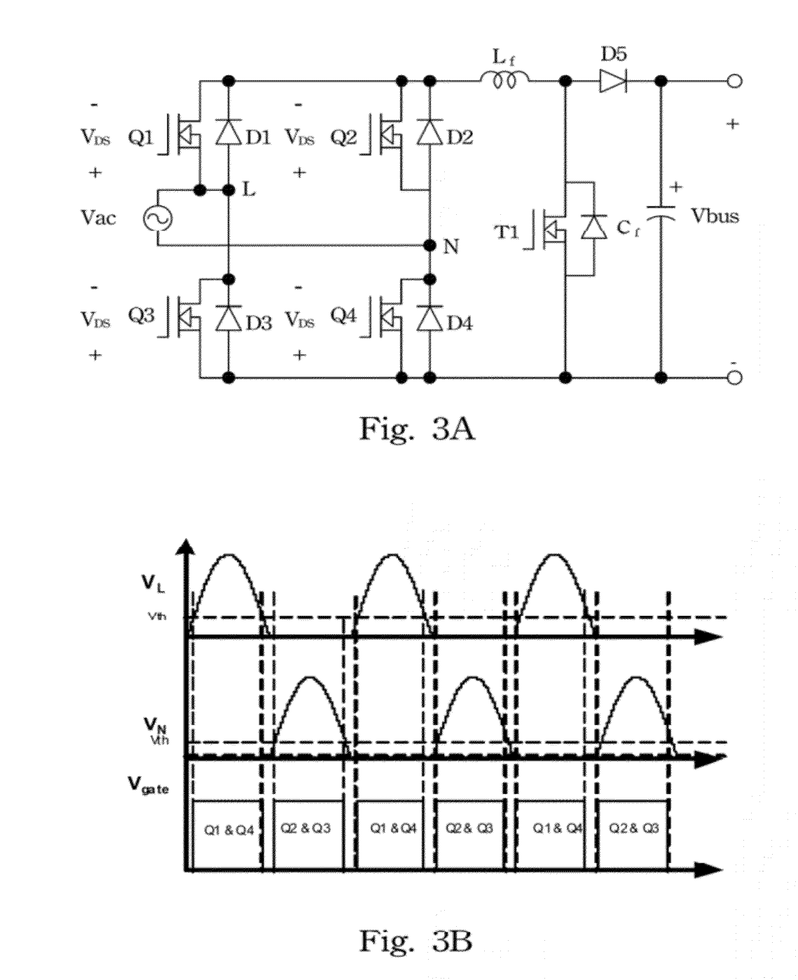

FIG. 3A schematically shows a circuit diagram of a converter device according to another embodiment of the present invention. FIG. 3B schematically shows a control waveform diagram of the converter device of FIG. 3A according to an embodiment of the present invention.

Reference is now made to both FIGS. 3A and 3B, and the power switch as shown below will use MOSFETs as an example configuration. The control tactic of the synchronous rectifying diode in the situation of the alternating current signal being normal as shown in FIG. 3B is described below. After detecting the alternating current signal and the rectifying diode is turned on, the corresponding MOSFET is turned on when the V_{DS} of the corresponding MOSFET decreases to the forward voltage drop of the diode. At this time, if only two corresponding synchronous rectifying diodes are turned off when the Vac alternating current signal is in the range between +Vth to −Vth, the normal control tactic can be achieved.

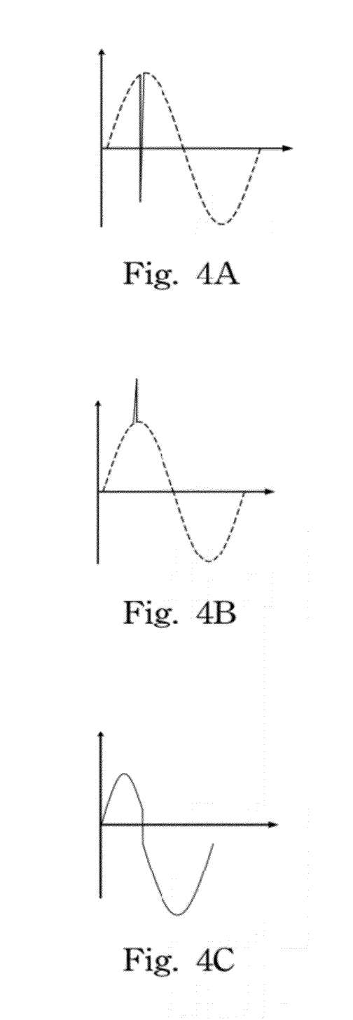

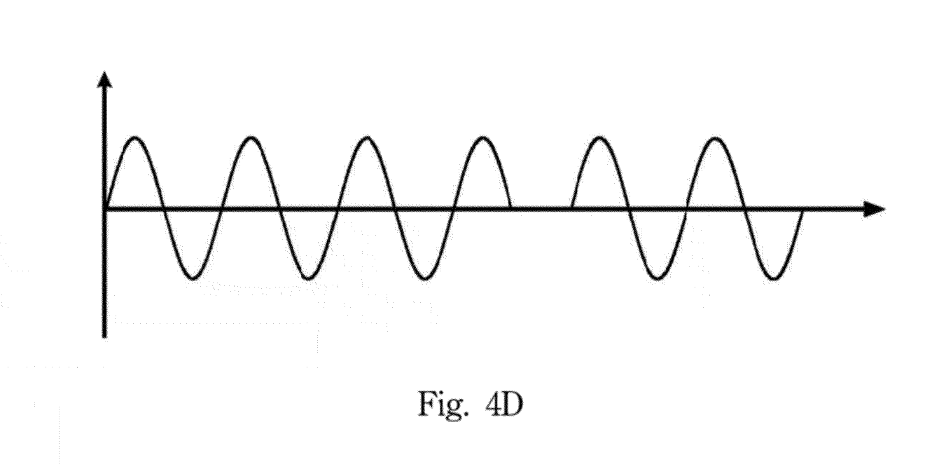

However, in the situation where the alternating current signal changes abruptly (for example, a surge or a situation involving a lightning strike), the phase of the alternating current signal is reversed in a few nanoseconds. As shown in FIGS. 4A˜4D, various situations that lead to the alternating current signal becoming abnormal are shown.

As shown in FIG. 3A, when the AC voltage works in the positive half period, the power switch Q1 and the power switch Q4 are turned on according to the operating principle of the synchronous rectifying as shown in FIG. 3B to decrease the voltage drop of the diode voltage drop so as to reduce the power loss. However, if the alternating current signal is changed as shown in FIGS. 4A˜4D at this time, the phase of the alternating current signal is reversed as shown in FIGS. 4A˜4D when the driver of the synchronous rectifying does not turn off the power switch Q1 and the power switch Q4 due to fact that the changed time of the alternating current signal is just a few nanoseconds. Therefore, the current flows through the diode D3 and the diode D2, which will cause the bridge wall to be a short circuit, and the instant high current burns out the diode D2 and diode D3. It is not sufficient to protect the rectifying diode if the MOSFET is merely turned on or turned off according to the change of the V_{DS} voltage when the above-mentioned situation of the alternating current signal being abnormal is encountered.

As a result, the protection device 130 as shown in FIG. 1 and FIG. 2 is needed to detect the change of the alternating current signal in the capacitor of the front end circuit. Through such detection, when the alternating current signal is abnormal, Q1 and Q4 are turned off earlier before the phase of the alternating current signal is reversed so that the converter device is back to the diode rectifying mode, and the main circuit can still operate properly at this time.

Reference is now made to both FIG. 1 and FIG. 2. The embodiment of the present invention provides the converter device 100 to protect the rectifying diode of the AC to DC converter 120.

In operation, the embodiment of the present invention can use the protection device 130 to detect the abnormality of the alternating current signal. The protection device 130 generates a driving signal as soon as the abnormality occurs to turn off the synchronous rectifying power switch (for example, Q1 and Q2 as shown in FIG. 2), and not to turn off the AC to DC converter 120 (or the rectifying diode thereof) so that power is continuously provided to the load.

The embodiment of the present invention performs three main processes. First, an abnormal condition of the alternating current signal is detected. Second, a protection device 130 turns off the synchronous rectifying power switch which is switched according to the frequency of the alternating current signal, in the synchronous rectifying power switch is connected with the diode in parallel. Third, when the protection device 130 receives the abnormal alternating current signal, only the synchronous rectifying power switch connected with diode in parallel is turned off so that the AC to DC converter 120 still can operate in diode rectifying mode so that the converter device 100 continues to provide power to the load.

First of all, the changes in the alternating current signal are detected. Since the change rate of the voltage of the capacitor is lower than that of the current of the capacitor, for example, the present invention detects the current of the capacitor before the diode which is switched according to the frequency of the alternating current signal in the converter device 100 for responding to the alteration of the alternating current signal as quick as possible. The current of the capacitor responds to the alternating current signal being abnormal earlier than the voltage of the capacitor when the alternating current signal is abnormal, and the abnormal signal activates the protection device 130 immediately to protect the AC to DC converter 120 from damage.

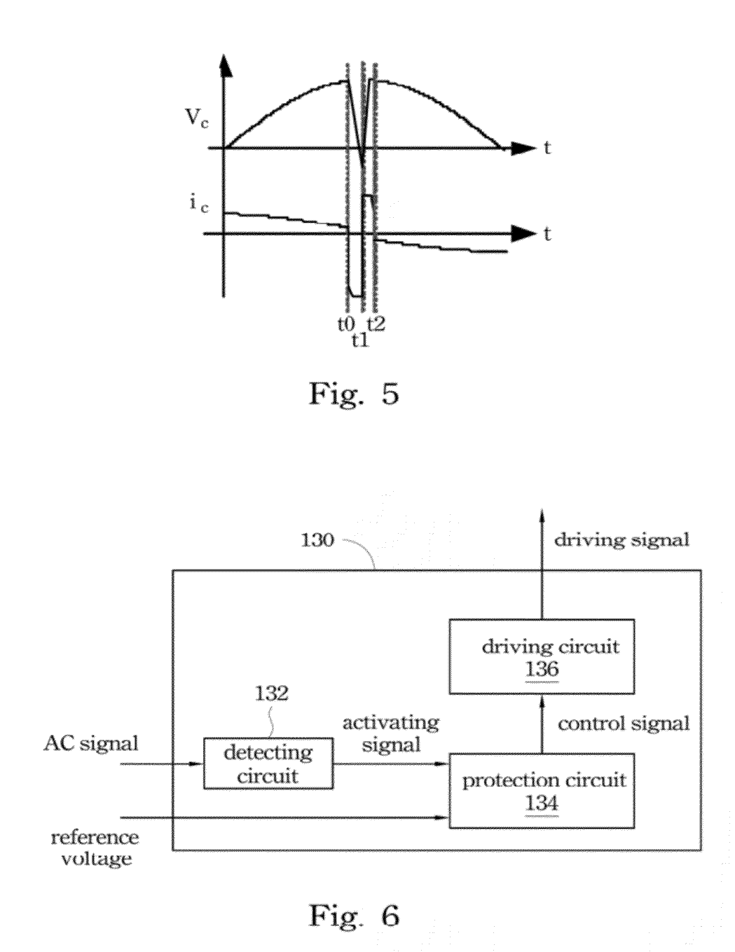

FIG. 5 schematically shows a waveform diagram of a changed relationship between a voltage of a capacitor and a current of the capacitor when the alternating current signal changes according to still another embodiment of the present invention. The change rate of the voltage of the capacitor is lower than that of the current of the capacitor as shown in FIG. 5.

As shown in FIG. 5, when the input alternating current signal changes at t0, the voltage of the capacitor changes in accordance with the input alternating current signal, and the voltage decreases quickly. However, as shown in the Figure, the capacitor current is decreased to the negative value quickly when the capacitor voltage is decreasing, and the larger the slope of the voltage, the larger that the negative value will be. The embodiment of the present invention can detect the current induced by the change of the capacitor to turn off the synchronous rectifying power switch in the AC to DC converter 120.

FIG. 6 schematically shows a circuit block diagram of the protection device 130 of FIG. 1 according to an embodiment of the present invention. In this embodiment, the protection device 130 comprises a detecting circuit 132 and a protection circuit 134. The detecting circuit 132 is electrically connected to the front end circuit 110 for detecting the alternating current signal. When the alternating current signal is abnormal, the detecting circuit 132 generates an activating signal according to the abnormal alternating current signal. The protection circuit 134 is electrically connected to the AC to DC converter 120 and the detecting circuit 132 for receiving the activating signal and generating a control signal according to the activating signal, in which the synchronous rectifying power switch is controlled according to the control signal.

In an optional embodiment, the protection device 130 further comprises a driving circuit 136. It is noted that the driving circuit 136 may be selectively used in the embodiment of the present invention. When using the driving circuit 136, the synchronous rectifying power switch is controlled to be turned on and turned off according to the control signal. In addition, when the driving circuit 136 is used in the embodiment of the present invention, the operation of the driving circuit 136 is as described below.

For instance, the driving circuit 136 is operable to generate the driving signal to drive the synchronous rectifying power switch and receive the control signal for stopping generating the driving signal (for example, generating a PWM signal) according to the control signal so as to turn off the synchronous rectifying power switch in the AC to DC converter 120.

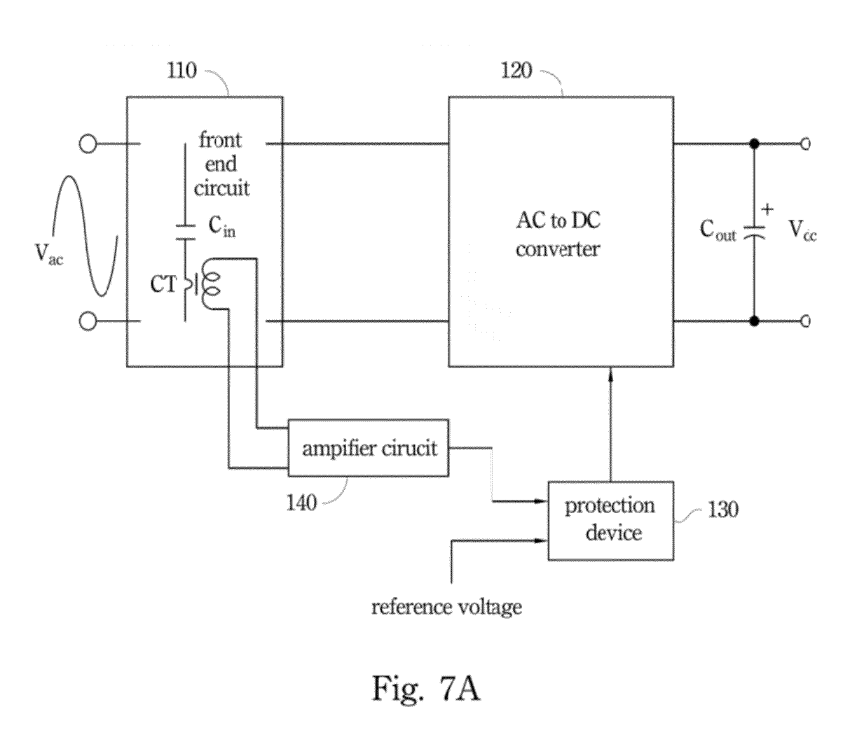

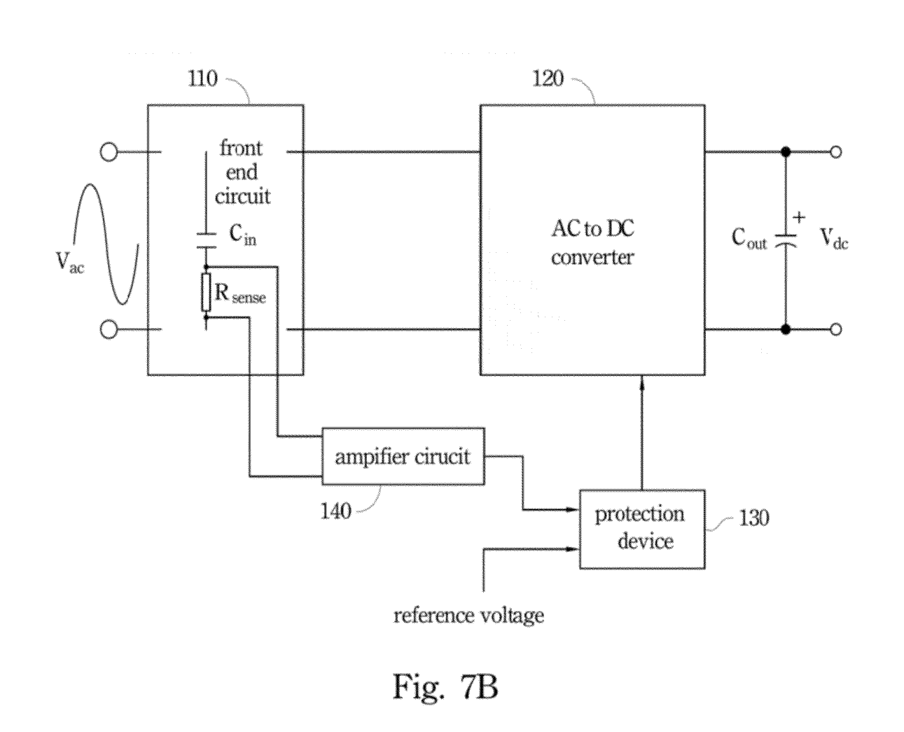

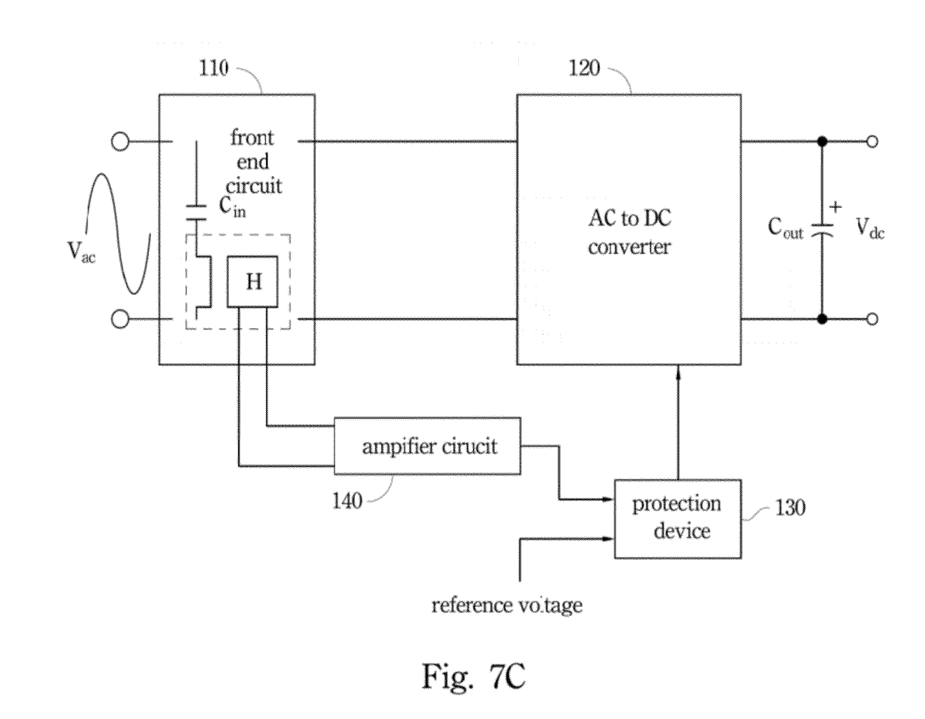

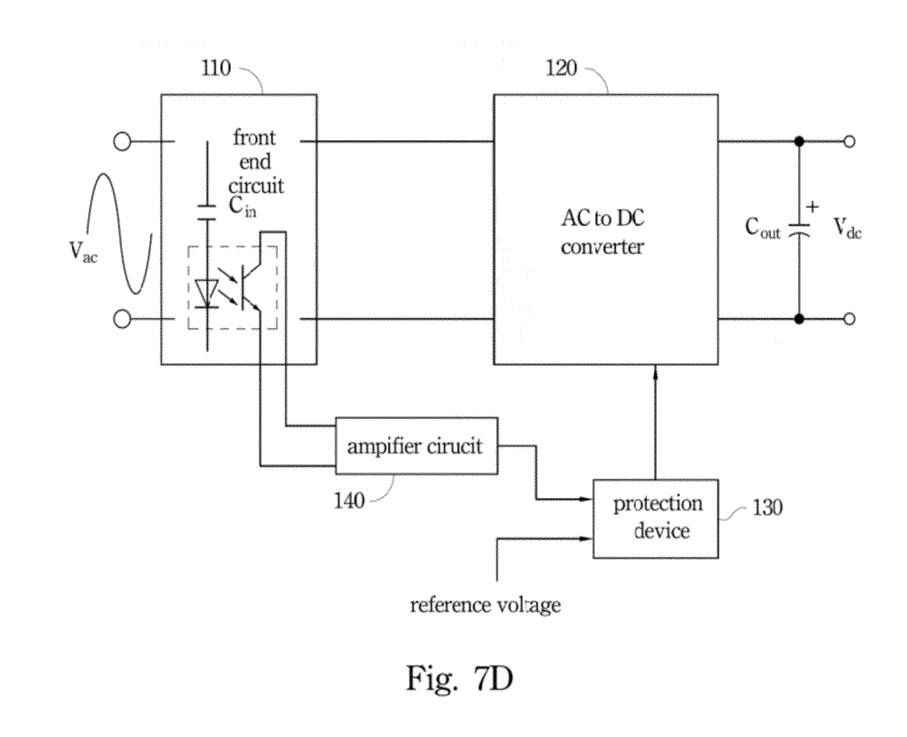

In operation, the detecting circuit 132 can be a current transformer (CT), a resistor detecting circuit, a hall sensor detecting circuit, or a photocoupler detecting circuit as shown in FIGS. 7A˜7D. The detecting circuit 132 outputs an activating signal as soon as the detecting circuit 132 detects the abnormal alternating current signal. After the protection circuit 134 receives the activating signal, the protection circuit 134 generates the control signal according to the activating signal. The synchronous rectifying power switch is controlled according to the control signal.

In another embodiment, the detecting circuit 132 outputs an activating signal according to the abnormal alternating current signal as soon as the detecting circuit 132 detects the abnormal alternating current signal. After the protection circuit 134 receives the activating signal, the protection circuit 134 compares the activating signal with the reference voltage to output the control signal.

For example, after the protection circuit 134 receives the activating signal, the protection circuit 134 outputs a control signal according to the activating signal to turn off the driving circuit 136 so as to stop generating the driving signal (for example, a PWM signal) to turn off the synchronous rectifying power switch.

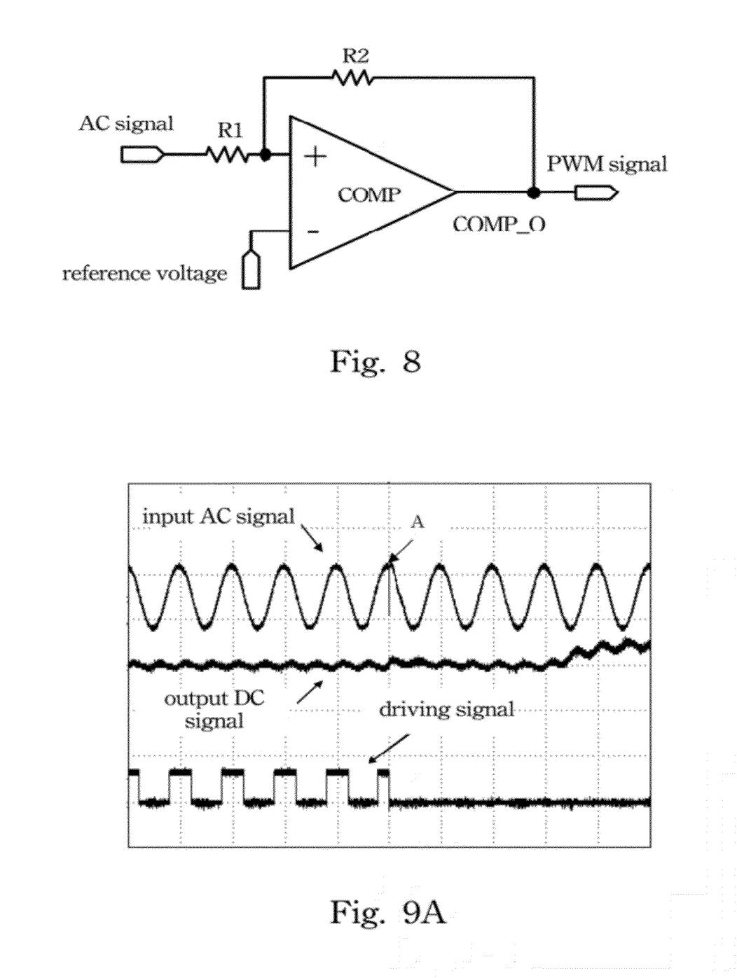

With respect to an actual implementation, the protection circuit 134 may be the circuit shown in FIG. 8, in which R1 is an input resistor, R2 is a feedback resistor, and R1, R2 and comparator COMP form a hysteresis protection circuit. The hysteresis protection circuit can avoid the operation of the protection motion to shock around the critical point. The comparator COMP is operable to receive the activating signal, and the comparator COMP compares the activating signal with the reference voltage to output a control signal (for example, a PWM signal). The comparator COMP outputs the control signal so as to turn off the synchronous rectifying power switch in the AC to DC converter 120.

In addition, as shown in FIGS. 7A˜7D, the converter device 100 can further comprise an amplifier circuit 140. As shown in these Figures, the amplifier circuit 140 can be disposed outside of the protection device 130 according to actual requirements. The amplifier circuit 140 is electrically connected to the detecting circuit 132, receives the alternating current signal, and amplifies the alternating current signal to provide the amplified alternating current signal to the detecting circuit. 132. Through such operation, the difference of the alternating current signal can be amplified to increase the accuracy of detecting the alternating current signal so as to increase the reliability of the method for protecting the converter device 100 of the present invention.

In an optional embodiment, the amplifier circuit 140 can be disposed in the protection device 130 according to actual requirements.

The alternating current signal that the detecting circuit 132 detects can be the alternating current signal of the capacitor preceding the diode in the AC to DC converter 120. For example, the alternating current signal can be the alternating current signal of the capacitor or the inductance in the front end circuit, or can be the alternating current signal of the capacitor in the front end of the AC to DC converter 120. The change in the alternating current signal can be detected from such a capacitor.

Operation principles are described below. The detecting circuit 132 is used to detect the alternating current signal of the filter capacitor which is in the front end of the AC to DC converter 120. Since the change rate of the current of the capacitor is larger than that of the voltage of the capacitor, the change in the alternating current signal can be detected earlier by detecting the current of the capacitor when the alternating current signal is abnormal. The amplifier circuit 140 amplifies the change in the alternating current signal, and the detecting circuit 132 detects the change in the alternating current signal to provide the change in the alternating current signal to the protection circuit 134.

Next, after the protection circuit 134 works, the protection circuit 134 does not turn off the main rectifying circuit of the AC to DC converter 120 but outputs a driving signal so as to turn off the synchronous rectifying power switch (for example, a synchronous MOSFET), which is connected in parallel with the diode of the AC to DC converter 120. At this time, the AC to DC converter 120 still can operate properly and provide power for the load. In other words, after the protection circuit 134 receives the activating signal, the protection circuit 134 outputs the control signal according to the activating signal to turn off the driving circuit 136 so as to stop generating the driving signal (for example, a PWM signal) for turning off the synchronous rectifying power switch. At this time, the AC to DC converter 120 can still operate in diode rectifying mode properly.

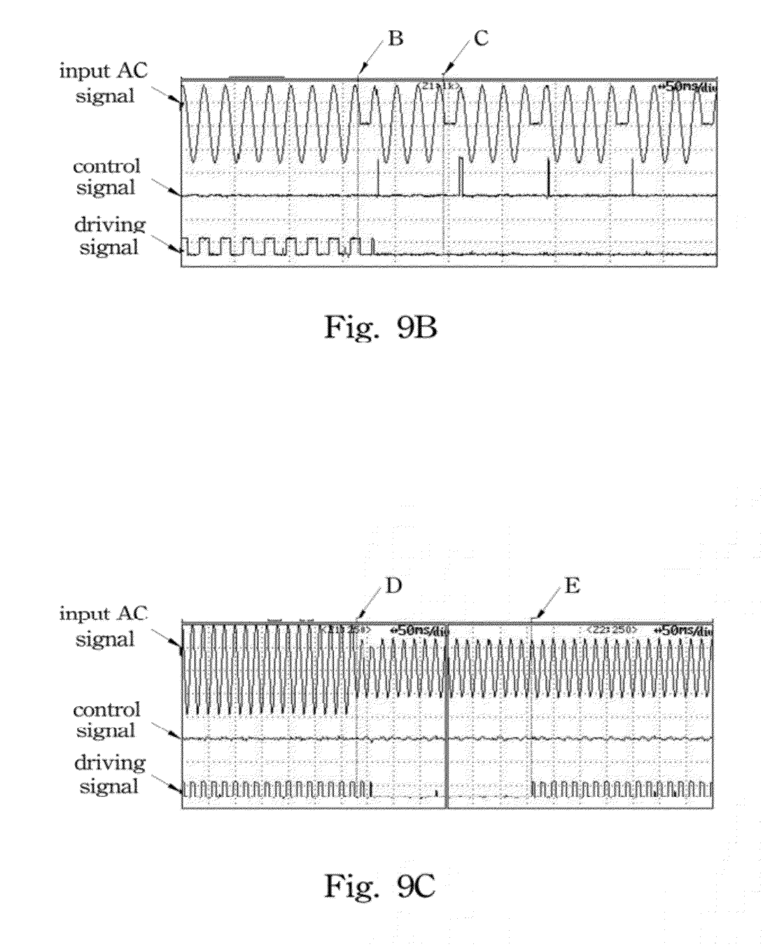

FIG. 9A schematically shows a waveform diagram of an input and an output of the converter device of FIG. 1 according to an embodiment of the present invention. FIG. 9B schematically shows a waveform diagram of an input and an output of the converter device of FIG. 1 according to an embodiment of the present invention. FIG. 9C schematically shows a waveform diagram of an input and an output of the converter device of FIG. 1 according to an embodiment of the present invention. As shown in FIG. 9A, when the abnormal alternating current signal occurs at A point, the detecting circuit 132 detects the change in the alternating current signal to generate an activating signal according to the abnormal alternating current signal. After the protection circuit 134 receives the activating signal, the protection circuit 134 outputs the control signal according to the activating signal to turn off the driving circuit 136 so as to stop generating the driving signal (for example, a PWM signal) so that the synchronous rectifying power switch is turned off. After the synchronous rectifying power switch is turned off, the converter device 100 continues outputting the direct current signal as shown in FIG. 9A. Hence, the embodiment of the present invention can not only provide reliable protection for the converter device 100 but can continue providing power to the load.

In addition, as shown in FIGS. 9B and 9C, when the abnormal alternating current signal occurs at B point and D point respectively, the operation mode of the embodiment of the present invention can turn off the synchronous rectifying power switch. The difference between FIGS. 9B and 9C is that the occurrence frequency of the abnormal alternating current signal is higher in FIG. 9B. Therefore, the detecting circuit 132 continues to detect the abnormal alternating current signal at C point so that the protection device 130 turns off the synchronous rectifying power switch for the duration of a predetermined time period. Furthermore, the abnormal alternating current signal merely occurs at D point in FIG. 9C so that as a result of the input alternating current signal being steady after a predetermined time period, the protection device 130 turns on the synchronous rectifying power switch again at E point so that the converter device 100 can operate in the synchronous rectifying mode.

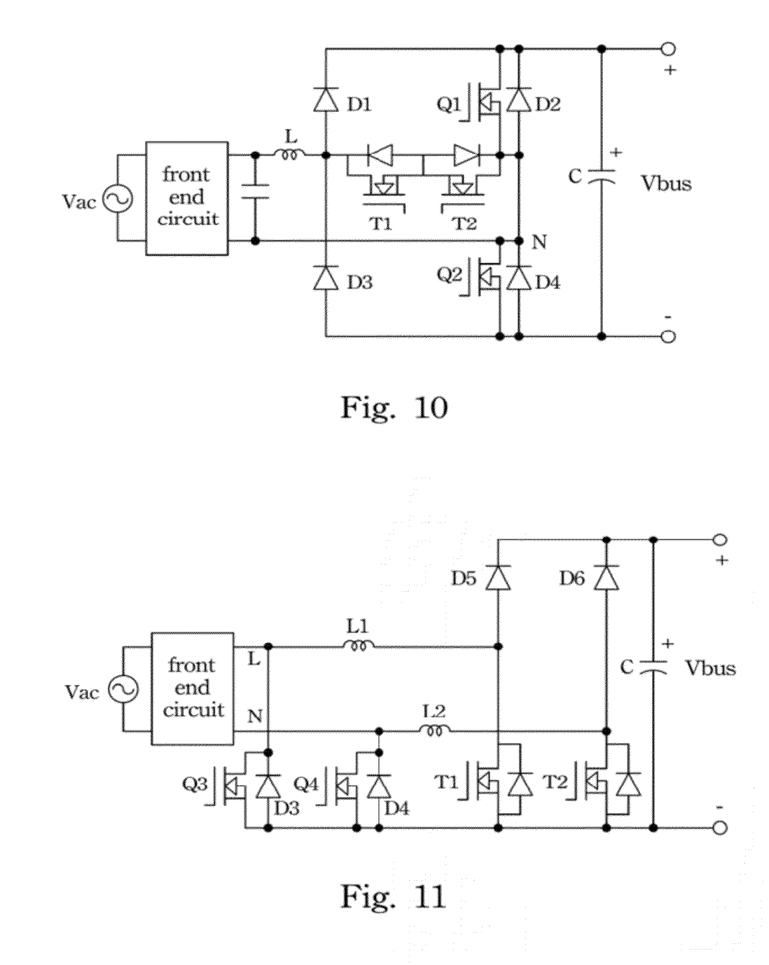

The embodiment of the present invention is not only used in the converter device 100 as shown in FIG. 2, every circuit adopting the synchronous rectifying mode in converter device falls within the scope of the embodiment of the present invention. Other power factor correction main circuits in the converter device are enumerated below. FIGS. 10˜13 schematically show circuit diagrams of power factor correction circuits without bridge rectifier according to embodiments of the present invention.

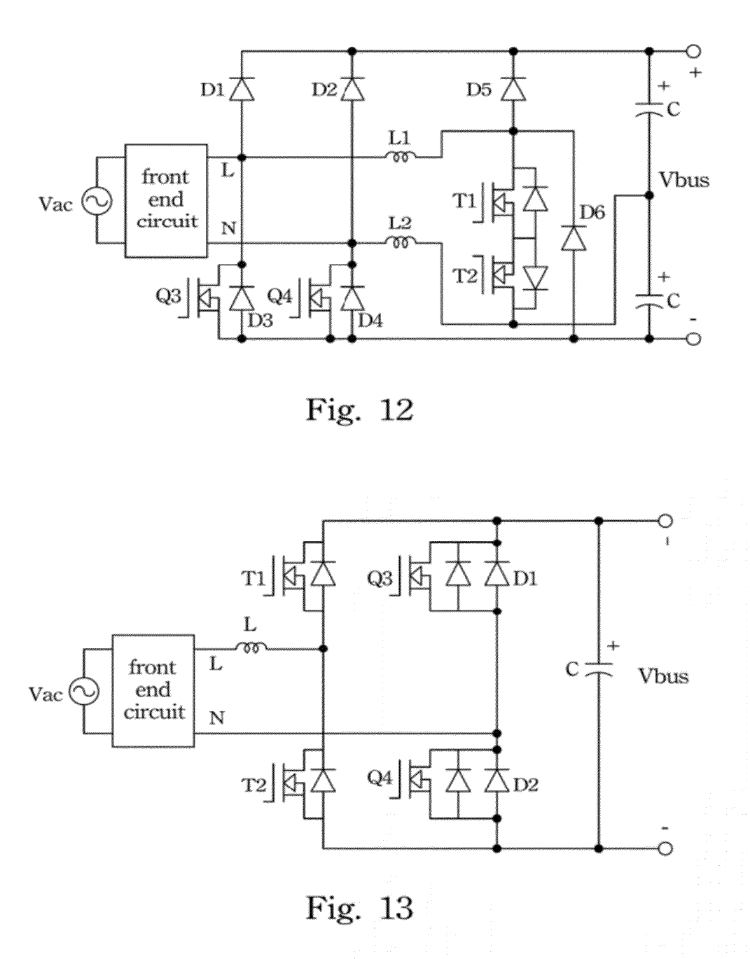

As shown in FIGS. 10˜13, the power switches Q1 and Q2 in FIG. 10, the power switches Q3 and Q4 in FIG. 11, the power switches Q3 and Q4 in FIG. 12, and the power switches Q3 and Q4 in FIG. 13 are all synchronous rectifying power switches (for example, MOSFETs) which are connected with the rectifying diode in parallel.

In summary, with the power factor correction main circuits mentioned above, the rectifying diode which is switched according to the frequency of the input alternating current signal in the power factor correction main circuit can be connected with the power switch to increase efficiency, but there is a need to add an additional protection circuit to reliably protect the rectifying diode from damage when the alternating current signal is abnormal.

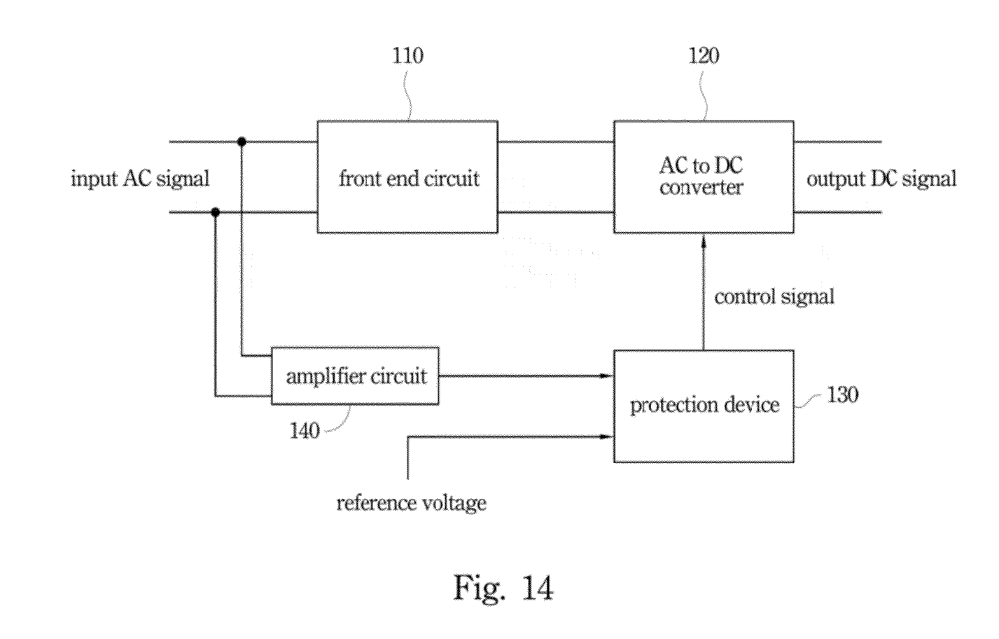

FIG. 14 schematically shows a circuit diagram of a converter device 100 according to still another embodiment of the present invention. As shown in FIG. 14, the detecting method the converter device 100 adopts is direct detection, which uses differential mode to directly detect the input alternating current signal. After the abnormal alternating current signal is detected, the amplifier circuit 140 amplifies the abnormal alternating current signal and provides the amplified signal to the protection device 130. The operation mode of the protection device 130 is mentioned in the description above, and accordingly, a detailed description regarding the operation mode of the protection device 130 will not be repeated for the sake of brevity.

For protecting the main circuit reliably, there is also a need to add an additional detecting circuit and a protection circuit so as to prevent the main circuit from damage caused by the additional synchronous power switch. The embodiment of the present invention not only provides the reliable detecting circuit 132 and the reliable protection circuit 134 but further provides a method for protecting the converter device 100. The method for protecting the converter device 100 is described below.

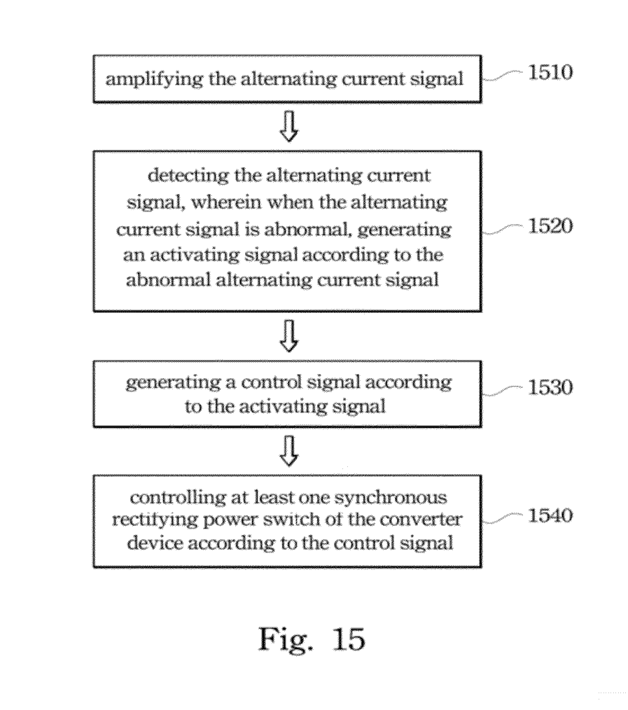

In embodiments of the present invention, a method for protecting the converter device 100 is provided. FIG. 15 schematically shows a flow diagram of a method for protecting the converter device 100 according to an embodiment of the present invention. The method for protecting the converter device 100 comprises the steps of amplifying an alternating current signal (step 1510); detecting the alternating current signal, in which when the alternating current signal is abnormal, an activating signal is generated according to the abnormal alternating current signal (step 1520); generating a control signal according to the activating signal (step 1530); and controlling at least one synchronous rectifying power switch of the converter device according to the control signal (step 1540).

In the converter device 100, the rectifying diode is disposed to rectify the input alternating current signal. However, the turn-on voltage of the diode is higher (about 0.6V˜1V), and the power loss is increased according to the increased current.

Because of the equivalent on-resistance of the power switches decreasing due to developments in the power switches, a power switch (for example, a MOSFET) and a diode can be connected in parallel to decrease power loss. The power switch is turned on as soon as the diode is turned on when the diode is connected to the power switch in parallel. At this time, the current flows through the power switch with lower equivalent resistance so as to decrease the voltage drop in the branch circuit to achieve the goal of decreasing power loss. Hence, the power switch is regarded as a synchronous rectifying power switch. In addition, the power switch is turned off as soon as the diode is turned off, and the circuit is in diode rectification mode. Thus, the above-mentioned principle is the synchronous rectification technology.

As a result of the fact that the diode being a passive component and the power switch is an active component, the synchronous rectifying technology needs a reliable protection method to ensure that no control error occurs in the power switch connected with the diode in parallel and the circuit can operate reliably. Therefore, the embodiment of the present invention provides a method for protecting the converter device 100 as shown in FIG. 15 to provide a reliable protection method for the converter device adopting the synchronous rectifying technology.

In step 1510, the step of amplifying the alternating current signal can be performed with the amplifier circuit 140 as shown in FIGS. 7A˜7D. After the alternating current signal is received, the amplifier circuit 140 can amplify the alternating current signal. Therefore, the difference of the alternating current signal can be amplified to increase the accuracy of detecting the alternating current signal so as to increase the reliability of the method for protecting the converter device 100 of the embodiment of the present invention.

In an optional embodiment, the alternating current signal can be the alternating current signal of the capacitor that precedes the diode in the AC to DC converter 120 as shown in FIG. 1. The alternating current signal is, for example, the input alternating current signal of the front end circuit 110 of the converter device 100 as shown in FIG. 2 or the alternating current signal of the filter capacitor in the front end of the AC to DC converter 120. The change in the alternating current signal can be detected from such a capacitor. Specifically, the front end circuit 110 can be a filter circuit for filtering the alternating current signal.

In step 1520, the alternating current signal can be detected by the detecting circuit 132 as shown if FIG. 6. When the detecting circuit 132 detects the abnormal alternating current signal, the detecting circuit 132 generates the activating signal according to the abnormal alternating current signal. The alternating current signal that the detecting circuit 132 detects can be the alternating current signal of the capacitor or the inductance preceding the diode of the AC to DC converter 120 as shown if FIG. 2. The alternating current signal is, for example, the alternating current signal of the capacitor in the front end circuit or the alternating current signal of the filter capacitor in the front end of the AC to DC converter 120. The change in the alternating current signal can be detected from such a capacitor.

The operation principle is described below. The detecting circuit 132 is used to detect the alternating current signal of the filter capacitor which is in the front end of the AC to DC converter 120. As a result of the change rate of the current of the capacitor being larger than that of the voltage of the capacitor, the change in the alternating current signal can be detected earlier by detecting the current of the capacitor when the alternating current signal is abnormal. The amplifier circuit 140 amplifies the change in the alternating current signal, and the detecting circuit 132 detects the change in the alternating current signal to provide the change in the alternating current signal to the protection circuit 134 as shown in FIG. 6.

In one embodiment, the detecting circuit 132 can be a current transformer (CT), a resistor detecting circuit, a hall sensor detecting circuit, or a photocoupler detecting circuit as shown in FIGS. 7A-7D.

In an optional embodiment, the alternating current signal can be the input alternating current signal of the front end circuit 110 of the converter device 100 as shown in FIG. 2. Specifically, the front end circuit 110 can be a filter circuit for filtering the alternating current signal.

In step 1530, the activating signal can be received by the protection circuit 134 as shown in FIG. 6, and the protection circuit 134 generates a control signal according to the activating signal. Specifically, the control signal can be generated by comparing the activating signal with the reference voltage by the protection circuit 134.

With respect to an actual implementation, the protection circuit 134 can be the circuit as shown in FIG. 8, in which R1 is an input resistor, R2 is a feedback resistor, and R1, R2 and comparator COMP form a hysteresis protection circuit. The hysteresis protection circuit can avoid the operation motion of the protection to shock around the critical point. The comparator COMP is operable to receive the activating signal, and the comparator COMP compares the activating signal with the reference voltage to output a control signal (for example, a PWM signal). The comparator COMP outputs the control signal so as to turn off the synchronous rectifying power switch in the AC to DC converter 120.

In step 1540, the step of controlling at least one synchronous rectifying power switch of the converter device 100 according to the control signal can be performed with the protection circuit 134. In operation, the protection circuit 134 is activated by the activating signal. At this time, the protection circuit 134 generates the control signal according to the activating signal so as to control at least one synchronous rectifying power switch of the converter device 100.

In addition, after the protection circuit 134 receives the activating signal and the protection circuit 134 is activated, the protection circuit 134 does not turn off the main rectifying circuit of the AC to DC converter 120 but outputs a driving signal so as to turn off the synchronous rectifying power switch (for example, a synchronous MOSFET) connected with the diode of the AC to DC converter 120 in parallel. At this time, the AC to DC converter 120 still can operate properly and provide power for the load.

In another embodiment, step 1540 can be performed with the driving circuit 136 as shown in FIG. 6. When the driving circuit 136 receives the control signal, the driving circuit 136 can turn off the synchronous rectifying power switch according to the control signal.

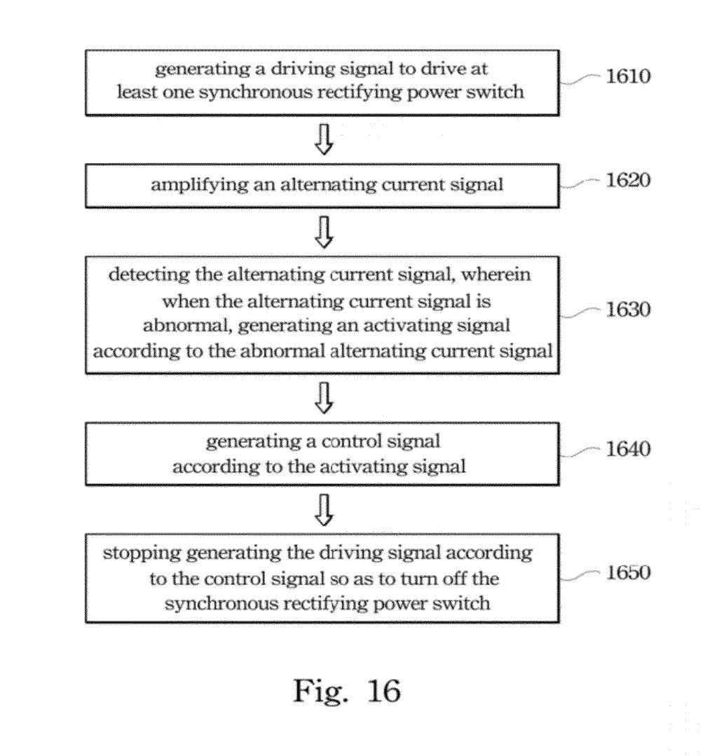

FIG. 16 schematically shows a flow diagram of a method for protecting the converter device 100 according to another embodiment of the present invention. The method for protecting the converter device 100 comprises the steps of generating a driving signal to drive at least one synchronous rectifying power switch (step 1610); amplifying an alternating current signal (step 1620); detecting the alternating current signal, in which when the alternating current signal is abnormal, an activating signal is generated according to the abnormal alternating current signal (step 1630); generating a control signal according to the activating signal (step 1640); and stopping generating the driving signal according to the control signal so as to turn off the synchronous rectifying power switch (step 1650).

In step 1610, the step can be performed with the driving circuit 136 as shown in FIG. 6. The driving circuit 136 can be used to generate the driving signal to drive the synchronous rectifying power switch so as to turn on and turn off the power switch according to the driving signal.

In step 1620, the step of amplifying the alternating current signal can be performed with the amplifier circuit 140 as shown in FIGS. 7A-7D. After the alternating current signal is received, the amplifier circuit 140 can amplify the alternating current signal. Therefore, the difference of the alternating current signal can be amplified to increase the accuracy of detecting the alternating current signal so as to increase the reliability of the method for protecting the converter device 100 of the embodiment of the present invention.

In 1630, the alternating current signal can be detected by the detecting circuit 132 as shown if FIG. 6. When the detecting circuit 132 detects the abnormal alternating current signal, the detecting circuit 132 generates the activating signal according to the abnormal alternating current signal.

In step 1640, the activating signal can be received by the protection circuit 134 as shown in FIG. 6, and the protection circuit 134 generates the control signal according to the activating signal.

Step 1620 to step 1640 correspond to step 1510 to step 1530 of the FIG. 15, respectively. Hence, a detailed description with respect to step 1620 to step 1640 is omitted herein for the sake of brevity.

In step 1650, after the driving circuit 136 receives the control signal generated by the protection circuit 134, the driving circuit 136 stops generating the driving signal. As a result, the synchronous rectifying power switch is turned off due to the driving circuit 136 stopping generating the driving signal control. In other words, when the protection circuit 134 receives the activating signal, the protection circuit 134 outputs the control signal to turn off the driving circuit 136 according to the activating signal so as to stop generating the driving signal (for example, a PWM signal) to turn off the synchronous rectifying power switch.

Reference is now made to FIG. 9. Experimental results by using the method for protecting the converter device 100 (for example, the method for protecting the converter device 100 as shown in FIG. 15 and FIG. 16) of the embodiment of the present invention will now be described. When the abnormal alternating current signal occurs at A point, the detecting circuit 132 detects the change in the alternating current signal to generate an activating signal. After the protection circuit 134 receives the activating signal, the protection circuit 134 outputs the control signal according to the activating signal so as to turn off the synchronous rectifying power switch. After the synchronous rectifying power switch is turned off, the converter device 100 continues outputting the direct current signal as shown in FIG. 9A. As such, the embodiment of the present invention can not only provide reliable protection for the converter device 100 but continues providing power to the load.

In addition, the method for protecting the converter device 100 of the embodiment of the present invention is not only used in the converter device 100 as shown in FIG. 2, every circuit adopting the synchronous rectifying mode in a converter device falls within the scope of the embodiment of the present invention. The power factor correction circuits without bridge rectifiers as shown in FIGS. 10˜13 illustrate exemplary circuits adopting synchronous rectifying power switches (for example, a MOSFET) connected with a rectifying diode in parallel.

In summary, with the power factor correction main circuits mentioned above, the rectifying diode which is switched according to the frequency of the input alternating current signal in the power factor correction main circuit can be connected with the power switch to increase efficiency. At this time, the method for protecting the converter device 100 of the embodiment in the present invention can provide a reliable protection method for the such circuits.

Those having skill in the art will appreciate that the method for protecting the converter device 100 can be performed with software, hardware, and/or firmware. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Those skilled in the art will recognize that optical aspects of implementations will typically employ optically oriented hardware, software, and or firmware.

In addition, those skilled in the art will appreciate that each of the steps of the method for protecting the converter device 100 named after the function thereof is merely used to describe the technology in the embodiment of the present invention in detail but not limited to. Therefore, combining the steps of said method into one step, dividing the steps into several steps, or rearranging the order of the steps is within the scope of the embodiment in the present invention.

In view of the foregoing embodiments of the present invention, many advantages of the present invention are now apparent. The embodiment of the present invention provides a method for protecting the converter device 100 and the converter device 100 implementing the method to detect the abnormal alternating current signal of the front end circuit of the converter device to activate the protection device 130 in the converter device 100 so that the protection device 130 turns off the synchronous rectifying power switch connected with the diode in parallel in the converter device 100 according to the abnormal alternating current signal. Hence, the problem of diodes burning out when the alternating current signal is abnormal can be avoided, and continued operation of the AC to DC converter in the diode rectification mode may be ensured so that electric power may be continuously provided to the load.

In addition, the embodiment of the present invention provides the amplifier circuit 140. The amplifier circuit 140 amplifies the alternating current signal and provides the amplified alternating current signal to the detecting circuit 132. Therefore, the difference of the alternating current signal can be amplified to increase the accuracy of detecting the alternating current signal so as to increase the reliability of the method for protecting the converter device 100 of the embodiment of the present invention. Furthermore, the embodiment of the present invention provides the hysteresis protection circuit comprising the input resistor R1, the feedback resistor R2, and the comparator COMP, and the hysteresis protection circuit functions as the protection circuit of the embodiment of the present invention. As a result, the hysteresis protection circuit can avoid the operation motion of the protection to shock around the critical point.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention, and the scope thereof is determined by the claims that follow.

What is claimed is:

1. A method for protecting a converter device, comprising:
detecting an alternating current signal, wherein when the alternating current signal is abnormal, generating an activating signal according to the abnormal alternating current signal;
generating a control signal according to the activating signal; and
controlling at least one synchronous rectifying power switch of the converter device according to the control signal.

2. The method according to claim 1, further comprising:
generating a driving signal to drive the synchronous rectifying power switch; and
stopping generating the driving signal according to the control signal so as to turn off the synchronous rectifying power switch.

3. The method according to claim 1, wherein the step of generating the control signal according to the activating signal comprises:
comparing the activating signal with a reference voltage to generate the control signal.

4. The method according to claim 1, wherein the step of controlling the synchronous rectifying power switch according to the control signal comprises:
turning off the synchronous rectifying power switch according to the control signal.

5. The method according to claim 1, further comprising:
amplifying the alternating current signal.

6. The method according to claim 1, wherein the alternating current signal is an alternating current signal of a front end circuit of the converter device.

7. A protection device, comprising:
a detecting circuit for detecting an alternating current signal, wherein when the alternating current signal is abnormal, the detecting circuit generates an activating signal according to the abnormal alternating current signal; and
a protection circuit for receiving the activating signal and generating a control signal according to the activating signal, wherein at least one synchronous rectifying power switch in a converter device is controlled according to the control signal.

8. The protection device according to claim 7, wherein the alternating current signal is an alternating current signal of a front end circuit of the converter device.

9. The protection device according to claim 7, further comprising:
a driving circuit for generating a driving signal to drive the synchronous rectifying power switch and receiving the control signal for stopping generating the driving signal according to the control signal so as to turn off the synchronous rectifying power switch.

10. The protection device according to claim 7, further comprising:
an amplifier circuit electrically connected to the detecting circuit for receiving the alternating current signal and amplifying the alternating current signal to provide the amplified alternating current signal to the detecting circuit.

11. The protection device according to claim 7, wherein the protection circuit comprises a comparing circuit, and the comparing circuit compares the activating signal with a reference voltage to output the control signal.

12. The protection device according to claim 7, wherein the detecting circuit is selected from the group consisting of a current transformer detecting circuit, a resistor detecting circuit, a hall sensor detecting circuit, and a photocoupler detecting circuit.

13. A converter device, comprising:
a front end circuit for performing a preliminary process on an alternating current signal;
an AC to DC converter electrically connected to the front end circuit and converting the alternating current signal into a direct current signal, the AC to DC converter comprising:
a plurality of diodes disposed to convert the alternating current signal into the direct current signal; and
at least one synchronous rectifying power switch, wherein each of the synchronous rectifying power switches is disposed with one of the diodes in parallel; and
a protection device, comprising:
a detecting circuit electrically connected to the front end circuit for detecting the alternating current signal, wherein when the alternating current signal is abnormal, the detecting circuit generates an activating signal according to the abnormal alternating current signal; and
a protection circuit electrically connected to the AC to DC converter and the detecting circuit for receiving the activating signal and generating a control signal according to the activating signal, wherein the synchronous rectifying power switch is controlled according to the control signal.

14. The converter device according to claim 13, wherein the front end circuit comprises a filter circuit, and the filter circuit filters the alternating current signal.

15. The converter device according to claim 13, wherein the power switch is switched according to the frequency of the alternating current signal.

16. The converter device according to claim 13, further comprising:
a driving circuit for generating a driving signal to drive the synchronous rectifying power switch and receiving the control signal for stopping generating the driving signal according to the control signal so as to turn off the synchronous rectifying power switch.

17. The converter device according to claim 13, further comprising:
an amplifier circuit electrically connected to the detecting circuit for receiving the alternating current signal and amplifying the alternating current signal to provide the amplified alternating current signal to the detecting circuit.

18. The converter device according to claim 13, wherein the protection circuit comprises a comparing circuit, and the comparing circuit compares the activating signal with a reference voltage to output the control signal.

19. The converter device according to claim 13, wherein the detecting circuit is selected from the group consisting of a current transformer detecting circuit, a resistor detecting circuit, a hall sensor detecting circuit, and a photocoupler detecting circuit.
